(19) United States
(12) Patent Application Publication
(10) Pub. No.: US 2006/0178467 A1
(43) Pub. Date: Aug. 10, 2006

(54) Tire treads with reduced hysteresis loss

(76) Inventors: Yasuo Fukushima, Tokyo (JP); Terrence E. Hogan, Akron, OH (US); Shunji Araki, Tokyo (JP); William L. Hergenrother, Akron, OH (US)

Correspondence Address: Jon D. Wood, Chief I.P. Counsel;Bridgestone Americas Holding, Inc., 1200 Firestone Parkway, Akron, OH, 44317, US

(21) Appl. No.: 11/331,663

(22) Filed: Jan. 13, 2006

Related U.S. Application Data
(60) Provisional application No. 60/644,164, filed on Jan. 14, 2005.

(51) Int. Cl. B60C 1/00; C08K 3/04

(52) U.S. Cl. 524/495

(57) ABSTRACT

A tire tread comprising a cured rubber, where at least a portion of the rubber derives from a functionalized polymer including an oxygen or sulfur-containing azaheterocycles, and a filler comprising oxidized carbon black.

This application gains benefit from U.S. Provisional Application No. 60/644,164, filed Jan. 14, 2005, which is incorporated herein by reference.

### FIELD OF THE INVENTION

One or more embodiments of this invention relate to compositions that can be vulcanized into tire treads that exhibit unexpectedly low hysteresis loss.

### BACKGROUND OF THE INVENTION

In the art of making tires, it is desirable to employ rubber vulcanizates that demonstrate reduced hysteresis loss, i.e., less loss of mechanical energy to heat. Hysteresis loss is often attributed to polymer free ends within the cross-linked rubber network, as well as the disassociation of filler agglomerates. The degree of dispersion of filler within the vulcanizate is also important, as increased dispersion provides better wear resistance.

Functionalized polymers have been employed to reduce hysteresis loss and increase bound rubber. The functional group of the functionalized polymer is believed to reduce the number of polymer free ends via interaction with filler particles. Also, this interaction reduces filler agglomeration, which thereby reduces hysteretic losses attributable to the disassociation of filler agglomerates (i.e., Payne effect).

Conjugated diene monomers are often anionically polymerized by using alkyllithium compounds as initiators. Selection of certain alkyllithium compounds can provide a polymer product having functionality at the head of the polymer chain. A functional group can also be attached to the tail end of an anionically-polymerized polymer by terminating a living polymer with a functionalized compound.

For example, trialkyltin chlorides, such as tributyl tin chloride, have been employed to terminate the polymerization of conjugated dienes, as well as the copolymerization of conjugated dienes and vinyl aromatic monomers, to produce polymers having a trialkyltin functionality at the tail end of the polymer. These polymers have proven to be technologically useful in the manufacture of tire treads that are characterized by improved traction, low rolling resistance, and improved wear.

Because functionalized polymers are advantageous, especially in the preparation of tire compositions, there exists a need for additional functionalized polymers. Moreover, because precipitated silica has been increasingly used as reinforcing particulate filler in tires, functionalized elastomers having affinity to silica filler are needed.

### SUMMARY OF THE INVENTION

In general the present invention provides a tire tread comprising a cured rubber, where at least a portion of the rubber derives from a functionalized polymer including an oxygen or sulfur-containing azaheterocycle, and a filler comprising oxidized carbon black.

The present invention also includes a rubber formulation comprising a rubber component, wherein at least 20% by weight of the rubber component includes a functionalized polymer including an oxygen or sulfur-containing azaheterocycle, and from about 20 to about 125 parts by weight of a filler component per 100 part by weight rubber, where said filler component comprises at least 1% by weight of an oxidized carbon black.

### DETAILED DESCRIPTION OF ILLUSTRATIVE EMBODIMENTS

Vulcanizates (e.g., tire treads) prepared from compositions that include (i) a polymer including an oxygen or sulfur-containing azaheterocycle group and (ii) oxidized carbon black demonstrate an unexpected reduction in hysteresis loss. It is believed that the oxygen or sulfur-containing azaheterocycle and the oxidized carbon black have a stronger affinity than an oxygen or sulfur-containing azaheterocycle has with unoxidized carbon black (e.g., conventional carbon black).

In one embodiment, the oxygen or sulfur-containing azaheterocycle comprises a closed-ring structure in which one or more of the atoms in the ring includes oxygen or sulfur. The ring may include five, six, or seven carbon atoms within the ring structure. The oxygen or sulfur-containing azaheterocycle may comprise more than one ring structure, and may comprise other heteroatoms such as nitrogen, silicon, and phosphorous. Also, the oxygen or sulfur-containing azaheterocycles may comprise saturated rings, partially saturated rings, aromatic rings, or a combination thereof.

In one or more embodiments, the polymer including the oxygen or sulfur-containing azaheterocycle can be defined by the formula 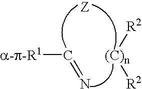
where α is a hydrogen atom or a functional group, Π is a polymer chain, R¹ is a bond or a divalent organic group, each R² is independently selected and is a hydrogen or a monovalent organic group, n is an integer from about 2 to about 6, and Z is an oxygen or sulfur atom.

The polymer chain (Π) substituent of the functionalized polymer includes an unsaturated polymer, which may also be referred to as a rubbery polymer. In one embodiment, the polymer chain substituent is a polymer that has a glass transition temperature (T_{g}) that is less than 0° C., in other embodiments less than −20° C., and less than −30° C.

Exemplary polymers include anionically polymerized polymers such as polybutadiene, polyisoprene, poly(styrene-co-butadiene), poly(styrene-co-butadiene-co-isoprene), poly(isoprene-co-styrene), and poly(butadiene-co-isoprene).

In one or more embodiments, the polymer has a number average molecular weight (Mₙ) of from about 5 to about 1,000 kg/mole, in other embodiments from about 50 to about 500 kg/mole, and in other embodiments 100 to about 300 kg/mole, as measured by using Gel Permeation Chromatography (GPC) calibrated with polystyrene standards and adjusted for the Mark-Houwink constants for the polymer in question.

In one or more embodiments, the polymer has a weight average molecular weight (M_{w}) of from about 5 to about 3,000 kg/mole, in other embodiments from about 50 to about 2,000 kg/mole, and in other embodiments 100 to about 1,200 kg/mole, as measured by using Gel Permeation Chromatography (GPC) calibrated with polystyrene standards and adjusted for the Mark-Houwink constants for the polymer in question.

R¹ includes a bond or a divalent organic group. The divalent organic group may include a hydrocarbylene group or substituted hydrocarbylene group such as, but not limited to, alkylene, cycloalkylene, substituted alkylene, substituted cycloalkylene, alkenylene, cycloalkenylene, substituted alkenylene, substituted cycloalkenylene, arylene, and substituted arylene groups, with each group containing from 1 carbon atom, or the appropriate minimum number of carbon atoms to form the group, up to about 20 carbon atoms. In one embodiment, R¹ contains a functional group that will react or interact with carbon black or silica or other wise have a desirable impact on filled rubber composition or vulcanizates.

R² may include a monovalent organic group. Monovalent organic groups may include hydrocarbyl groups such as, but not limited to, alkyl, cycloalkyl, substituted cycloalkyl, alkenyl, cycloalkenyl, substituted cycloalkenyl, aryl, allyl, substituted aryl, aralkyl, alkaryl, and alkynyl groups, each group may contain from 1 carbon atom, or the appropriate minimum number of carbon atoms to form the group, up to 20 carbon atoms. These hydrocarbyl groups may contain heteroatoms such as, but not limited to, nitrogen, oxygen, silicon, sulfur, and phosphorus atoms. In one or more embodiments, R² has from 1 to about 4 carbon atoms.

“Substituted hydrocarbylene group” is a hydrocarbylene group in which one or more hydrogen atoms have been replaced by a substituent such as an alkyl group. R¹ may also contain one or more heteroatoms such as, but not limited to, nitrogen, oxygen, silicon, sulfur, and phosphorus atoms.

Functional groups (α) which may also be referred to as filler interactive groups, include those groups or substituents that react or interact with rubber or rubber fillers or otherwise have a desirable impact on filled rubber compositions or vulcanizates. In one or more embodiments, α reduces the 50° C. hysteresis loss of vulcanizates including the functionalized polymer when compared to similar vulcanizates with polymer not including α (i.e., a comparable polymer without α). These groups may include trialkyl tin substituents, cyclic amine groups, aryl or alkylthioacetals. Exemplary trialkyl tin substituents are disclosed in U.S. Pat. No. 5,268,439, which is incorporated herein by reference. Exemplary cyclic amine groups are disclosed in U.S. Pat. Nos. 6,080,853, 5,786,448, 6,025,450, and 6,046,288, which are incorporated herein by reference. Exemplary aryl or alkylthioacetals (e.g., dithianes) are disclosed in International Publication No. WO 2004/041870, which is incorporated herein by reference.

Several sulfur-containing heterocycles are disclosed in WO 2004/020475 A1, which is incorporated herein by reference. Examples of sulfur-containing heterocycle groups include thiazole, thiazoline, thiazolidine, thiadiazole, thiadiazine, dithiazine, benzothiazole, isothiazole, dihydroisothiazole, thiazolyl groups, and substituted forms thereof.

Useful oxygen-containing heterocycles are disclosed in U.S. Pat. No. 6,596,798, which is incorporated herein by reference. Examples of useful oxygen-containing heterocycle groups include oxazoline, isoxazole, isoxazolyl, furazan, furazanyl, dihydro 1,3-oxazine, dihydro 1,3-oxazepine groups, and substituted forms thereof.

The polymer bearing the oxygen or sulfur-containing azaheterocycle (i.e., the functionalized polymer) can be prepared by using techniques known in the art. In this regard, U.S. Pat. No. 6,596,798 and WO 2004/020475 are incorporated herein by reference. In general, compounds including an oxygen or sulfur-containing azaheterocycle can be reacted with a living polymer to incorporate the oxygen or sulfur-containing azaheterocycle to the polymer chain. In one or more embodiments, the oxygen or sulfur-containing azaheterocycle is incorporated at the terminus of the polymer chain. In one or more embodiments, the polymer chain is synthesized by employing anionic, living polymerization techniques, and the oxygen or sulfur-containing azaheterocycle is added to or tethered to the terminus of the polymer chain by way of a substitution-type reaction or an addition-type reaction.

Useful oxygen-containing azaheterocycle compounds that can be reacted with a living polymer include 2-(1,1-dimethyl-2-chloroethyl)-2-oxazoline, 2-(1,1-dimethyl-2-chloroethyl-4,4-dimethyl-2-oxazoline, or mixtures thereof. Useful sulfur-containing heterocycles that can be reacted with a living polymer include 2-methylthio-2-thiazoline, 2-ethylthio-2-thiazoline, 2-propylthio-2-thiazoline, 2-butylthio-2-thiazoline, 2-pentylthio-2-thiazoline, 2-hexylthio-2-thiazoline, 2-heptylthio-2-thiazoline, 2-dodecylthio-2-thiazoline, 2-phenylthio-2-thiazoline, 2-benzylthio-2-thiazoline, 2-chloro-2-thiazoline, 2-bromo-2-thiazoline, 2-iodo-2-thiazoline, 2-dimethylamino-2-thiazoline, 2-diethylamino-2-thiazoline, 2-methoxy-2-thiazoline, 2-ethoxy-2-thiazoline, 2-(N-methyl-N-3-trimethoxysilylpropyl)-thiazoline, 2-methylthio-1-aza-3-thia-bicyclo[3-4-0]-nonene, and mixtures thereof.

Oxidized carbon black is known. In general, carbon black can be oxidized by using any suitable conventional technique such as oxidation by ozone, dichromate, or oxidizing acids such as nitric acid. Examples of suitable methods of producing oxidized carbon blacks are disclosed in U.S. Pat. Nos. 3,914,148; 4,075,140; and 4,075,157, which are hereby incorporated by reference. Many carbon black compounds can be oxidized. In one embodiment, the carbon black includes those produced by the incomplete combustion or thermal decomposition of natural gas or petroleum oil including channel blacks, furnace black, and thermal blacks.

In one embodiment, the oxidized carbon blacks are characterized by a relatively high acid content. These may include carbon blacks having total acid content of at least about 10 milliequivalents per kilogram of oxidized carbon black, in other embodiments at least 50 milliequivalents per kilogram of oxidized carbon black, in other embodiments at least 100 milliequivalents per kilogram of oxidized carbon black, in other embodiments at least 500 milliequivalents per kilogram of oxidized carbon black, in other embodiments at least 750 milliequivalents per kilogram of oxidized carbon black, and in other embodiments at least 1,000 milliequivalents per kilogram of oxidized carbon black, where the milliequivalents refer to the milliequivalents of carboxyl and/or phenolic groups.

In one or more embodiments, the oxidized carbon blacks may further be characterized by their relatively high volatile content. This includes oxidized carbon blacks having a volatile content of at least about 2 percent by weight or at least about 3.5 percent by weight. In one or more embodiments, the average particle size of the carbon blacks used in connection with the invention may range of from about 100 to 600 angstroms, or in other embodiments from about 200 to about 400 angstroms.

The oxygen or sulfur-containing azaheterocycle functionalized polymers of this invention are particularly useful in preparing tire components such as tire treads. These tire components can be prepared by using the functionalized polymers of this invention alone or together with other rubbery polymers. Other rubbery elastomers that may be used include natural and synthetic elastomers. The synthetic elastomers typically derive from the polymerization of conjugated diene monomers. These conjugated diene monomers may be copolymerized with other monomers such as vinyl aromatic monomers. Other rubbery elastomers may derive from the polymerization of ethylene together with one or more α-olefins and optionally one or more diene monomers.

Useful rubbery elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched and star shaped. Other ingredients that are typically employed in rubber compounding may also be added.

In one embodiment, the rubber component of the tire formulations (and ultimately the rubber component of the vulcanizates) include the functionalized polymers disclosed herein (i.e., those bearing the an oxygen or sulfur-containing azaheterocycle) together with conventional rubber polymer. In one or more of these embodiments, the rubber component of the tire formulations includes at least 20% by weight, in other embodiments at least 40% by weight, and in other embodiments at least 60% by weight, based upon the entire weight of the rubber component, of the functionalized polymer of this invention. In one or more embodiments, the rubber component of the tire formulations includes less than or equal to 100% by weight, in other embodiments less than 90% by weight, and in other embodiments less than 80% by weight, based on the entire weight of the rubber component, of the functionalized polymer of this invention.

The rubber compositions may include additional fillers besides the oxidized carbon black. Other fillers may include standard carbon black, silica, aluminum hydroxide, magnesium hydroxide, clays (hydrated aluminum silicates), and mixtures thereof.

In general, tire formulations, particularly those useful in the manufacture of tires, include from about 20 to about 125, in other embodiments from about 25 to about 100, in other embodiments from about 40 to about 80, and in other embodiments from about 45 to about 60, parts by weight filler per 100 parts by weight rubber. This filler component can include one or more filler materials.

In one or more embodiments of this invention, the filler component includes at least about 1% by weight, in other embodiments at least about 2% by weight, in still in other embodiments at least about 5% by weight, in other embodiments at least 10% by weight of oxidized carbon black, based on the entire weight of the filler component. Within one or more of these embodiments, the filler component may include less than or equal to about 100% by weight, in other embodiments less than about 75% by weight, in still other embodiments less than about 50% by weight oxidized carbon black based on the entire weight of the filler component. In one or more embodiments, the entire filler component includes one or more oxidized carbon blacks.

A multitude of rubber curing agents may be employed, including sulfur or peroxide-based curing systems. Curing agents are described in 20 Kirk-Othmer, Encyclopedia of Chemical Technology, 365-468, (3^{rd} Ed. 1982), particularly Vulcanization Agents and Auxiliary Materials, 390-402, and A. Y. Coran, Vulcanization in Encyclopedia of Polymer Science and Engineering, (2^{nd} Ed. 1989), which are incorporated herein by reference. Vulcanizing agents may be used alone or in combination.

Other ingredients that may be employed include accelerators, oils, waxes, scorch inhibiting agents, processing aids, zinc oxide, tackifying resins, reinforcing resins, fatty acids such as stearic acid, peptizers, and one or more additional rubbers.

These stocks are useful for forming tire components such as treads, subtreads, black sidewalls, body ply skins, bead filler, and the like. The preparation of vulcanizable compositions and the construction and curing of the tire is not affected by the practice of this invention.

The vulcanizable rubber composition may be prepared by forming an initial masterbatch that includes the rubber component and filler. This initial masterbatch is mixed at a starting temperature of from about 25° C. to about 125° C. with a discharge temperature of about 135° C. to about 180° C. To prevent premature vulcanization (also known as scorch), this initial masterbatch generally excludes any vulcanizing agents. Once the initial masterbatch is processed, the vulcanizing agents may be introduced and blended into the initial masterbatch at low temperatures in a final mix stage, which does not initiate the vulcanization process. Optionally, additional mixing stages, sometimes called remills, can be employed between the masterbatch mix stage and the final mix stage. Rubber compounding techniques and the additives employed therein are generally known as disclosed in Stephens, The Compounding and Vulcanization of Rubber, in Rubber Technology (2^{nd} Ed. 1973). The mixing conditions and procedures applicable to silica-filled tire formulations are also well known as described in U.S. Pat. Nos. 5,227,425, 5,719,207, 5,717,022, and European Patent No. 890,606, all of which are incorporated herein by reference.

Where the vulcanizable rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it is heated to about 140 to about 180° C. Cured or crosslinked rubber compositions may be referred to as vulcanizates, which generally contain three-dimensional polymeric networks that are thermoset. The other ingredients, such as processing aides and fillers, are generally evenly dispersed throughout the vulcanized network. Pneumatic tires can be made as discussed in U.S. Pat. Nos. 5,866,171, 5,876,527, 5,931,211, and 5,971,046, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

### Example 1

Four tire formulations were prepared. In general, the formulations varied based upon the use of a polymer bearing a sulfur-containing heterocycle and the use of oxidized carbon black. A summary of the key variables employed in each sample is set forth in Table I.

TABLE I

| | | |
|---|---|---|
| Sample 1 | Mono-Functionalized Polymer | Un-Oxidized Carbon Black |
| Sample 2 | Mono-Functionalized Polymer | Oxidized Carbon Black |
| Sample 3 | Difunctionalized Polymer | Un-Oxidized Carbon Black |
| Sample 4 | Difunctionalized Polymer | Oxidized Carbon Black |

The mono-functionalized polymer was prepared as follows. To a five-gallon reactor equipped with turbine agitator blades was added 4.88 kg hexane, 1.25 kg 32.8 weight percent styrene in hexane, and 7.41 kg 22.1 weight percent butadiene in hexane. To the reactor was charged of 0.75 M lithium in hexane and 3.83 mL of 1.6 M 2,2′-di(tetrahydrofuryl)propane in hexane and the batch temperature was controlled at 49° C. After approximately one hour, the batch was cooled to 32° C. and a measured amount of live poly(styrene-co-butadiene) cement was then transferred to a sealed nitrogen purged 0.9 L bottle. The bottle contents were then terminated with isopropanol, coagulated and drum dried. The isolated polymer had the following properties: Mₙ=129 kg/mol, PDI=1.05, T_{g}=−36.2° C. The unfunctionalized polymer was not coupled.

The difunctionalized polymer was prepared as follows: a second bottle of cement was transferred from the five-gallon reactor used in Example 1 and to this was added 1 mole of 2-methylthio-2-thiazoline per equivalent of lithium. The bottle was heated to 50° C. for 30 minutes. The bottle contents were then coagulated and drum dried. The isolated polymer had the following properties: Mₙ=145 kg/mol, PDI=1.17, T_{g}=−36.2° C.

The non-oxidized carbon black (i.e., conventional carbon black) was an N234 carbon black, which was characterized by a dibutylphthalate (DBP) absorption of 128 cc/100 g per ASTM D-2414, an iodine absorption (IA) per ASTM D-1510 of 122 mg/g, an nitrogen surface area (N2SA) per ASTM D-4820, of 119 m²/g, and an Π of 0.983, where Π equals N2SA/IA. The oxidized carbon black was formed by treating N234 carbon black with nitric acid (i.e., HNO₃), and the resulting oxidized product was characterized by a DBP of 124 cc/100 g, an IA of 86 mg/g, an N2SA of 123 m²/g, and an 90 of 1.422.

The formulations were mixed by employing conventional two-stage mixing procedures. That is, in a first stage, 100 parts by weight polymer, 45 parts by weight carbon black, 1 part by weight wax, 0.9 parts by weight antiozonant, 2.5 parts by weight zinc oxide, 2 parts by weight stearic acid, and 10 parts by weight oil were mixed to a drop temperature to about 153-164° C. Each masterbatch was then mixed with 1.3 parts by weight sulfur, 1.7 parts by weight CBS accelerator, and 0.2 parts by weight DPG accelerator and mixed to a drop temperature of about 100° C.

Samples of each of the formulations were cured into test specimens by employing conventional techniques (e.g., 15 minutes at 171° C.), and the cured samples were subjected to various physical and dynamic tests. The results of these tests are set forth in Table II.

TABLE II

| | Formulation | | | |
|---|---|---|---|---|
| | 1 | 2 | 3 | 4 |
| ML₁₊₄ @ 130° C. | 27.8 | 31.8 | 49.1 | 50.3 |
| Bound Rubber (%) | 30.5 | 31.3 | 46.4 | 42.75 |
| Strain Sweep (MPa) | | | | |
| G′ (50° C., 15 Hz) (MPa) | 1.81 | 1.99 | 1.77 | 1.77 |
| tan δ (50° C., 15 Hz) | 0.121 | 0.117 | 0.104 | 0.093 |
| ΔG′ (MPa) (0.1-20% strain) | 0.562 | 0.540 | 0.420 | 0.330 |
| Δtanδ (0.1-20% strain) | 0.031 | 0.026 | 0.020 | 0.016 |
| Temperature Sweep | | | | |
| −25° C. | | | | |
| G′ (Mpa) | 288.0 | 368.1 | 366.7 | 371.6 |
| tan δ | 0.669 | 0.622 | 0.622 | 0.618 |
| 0° C. | | | | |
| G′ (MPa) | 4.84 | 6.73 | 5.91 | 5.43 |
| tan δ | 0.467 | 0.494 | 0.522 | 0.537 |
| 25° C. | | | | |
| G′ (MPa) | 2.69 | 3.21 | 3.19 | 2.95 |
| tan δ | 0.149 | 0.151 | 0.155 | 0.141 |
| 50° C. | | | | |
| G′ (MPa) | 2.14 | 2.64 | 2.56 | 2.45 |
| tan δ | 0.113 | 0.118 | 0.111 | 0.100 |
| 75° C. | | | | |
| G′ (MPa) | 1.88 | 2.35 | 2.30 | 2.21 |
| tan δ | 0.096 | 0.108 | 0.094 | 0.088 |

Mooney viscosity measurement was conducted at 130° C. using a large rotor. The Mooney viscosity was recorded as the torque when the rotor has rotated 5 for 4 minutes. The sample is preheated at 130° C. for 1 minute before the rotor starts.

The bound rubber content test was used to determine the percent of polymer bound to filler particles in tire tread stocks. Bound rubber was measured by immersing small pieces of uncured stocks in a large excess of toluene for three days. The soluble rubber was extracted from the sample by the solvent. After three days, any excess toluene was drained off and the sample was air dried and then dried in an oven at approximately 100° C. to a constant weight. The remaining pieces form a weak coherent gel containing the filler and some of the original rubber. The amount of rubber remaining with the filler is the bound rubber. The bound rubber content is then calculated according to the following:

$$\% Bound Polymer = \frac{100 ( Wd - F )}{R} \qquad ( 1 )$$

where Wd is the weight of dried gel, F is the weight of filler in gel or solvent insoluble matter (same as weight of filler in original sample), and R is the weight of polymer in original sample.

Strain and temperature sweeps were used to determine dynamic properties. Temperature sweep experiments were conducted with a frequency of 15 Hz using 0.5 % strain for temperature ranging from −100° C. to −10° C., and 2% strain for the temperature ranging from −10° C. to 100° C. ΔG′ is the change in G′ from 0.1% to 20% strain. Payne effect (ΔG′) data were obtained from the strain sweep experiment at a frequency of 15 Hz at 50° C. with strain sweeping from 0.1% to 20%.

Various modifications and alterations that do not depart from the scope and spirit of this invention will become apparent to those skilled in the art. This invention is not to be duly limited to the illustrative embodiments set forth herein.

What is claimed is:

1. A tire tread comprising:
a cured rubber, where at least a portion of the rubber derives from a functionalized polymer including an oxygen or sulfur-containing azaheterocycle; and
a filler comprising oxidized carbon black.

2. The tire tread of claim 1, where said oxidized carbon black is obtained by treatment with ozone, dichromate, or nitric acid.

3. The tire tread of claim 1, where the oxidized carbon black is characterized by having a total acid content of at least about 100 milliequivalents per kilogram of oxidized carbon black.

4. The tire tread of claim 1, where the oxidized carbon black is characterized by having a total acid content of at least about 500 milliequivalents per kilogram of oxidized carbon black.

5. The tire tread of claim 1, where the oxidized carbon black is characterized by having a total acid content of at least about 750 milliequivalents per kilogram of oxidized carbon black.

6. The tire tread of claim 1, where the oxidized carbon black is characterized by a volatile content of at least about 2% by weight.

7. The tire tread of claim 1, where the oxidized carbon black is characterized by a volatile content of at least about 3.5% by weight.

8. The tire tread of claim 1, where the oxidized carbon black is characterized by an average particle size of from about 100 to about 600 angstroms.

9. The tire tread of claim 1, where the oxidized carbon black is characterized by an average particle size of from about 200 to about 400 angstroms.

10. The tire tread of claim 1, where the tread includes from about 20 to about 125 parts by weight filler per 100 parts by weight rubber, and where the filler comprises at least 1% by weight oxidized carbon black.

11. The tire tread of claim 1, where the tread includes from about 25 to about 100 parts by weight filler per 100 parts by weight rubber, and where the filler comprises at least 5% by weight oxidized carbon black.

12. The tire tread of claim 11, where the filler includes at least 10% by weight oxidized carbon black.

13. The tire tread of claim 1, wherein the cured rubber includes at least 20% by weight of the functionalized polymer based on the entire weight of the rubber.

14. The tire tread of claim 1, wherein the cured rubber includes at least 40% by weight of the functionalized polymer based on the entire weight of the rubber.

15. The tire tread of claim 1, where the functionalized polymer is defined by the formula 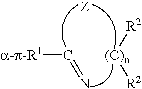
where α is a hydrogen atom or a filler-interactive group, Π is a polymer chain, R¹ is a bond or a divalent organic group, each R² is independently selected and is a hydrogen or a monovalent organic group, n is an integer from about 2 to about 6, and Z is an oxygen or sulfur atom.

16. The tire tread of claim 1, where the functionalized polymer includes at least one functional group selected from the group consisting of thiazole, thiazoline, thiazolidine, thiadiazole, thiadiazine, dithiazine, benzothiazole, isothiazole, dihydroisothiazole, thiazolyl groups, and substituted forms thereof.

17. The tire tread of claim 1, where the functionalized polymer includes at least one functional group selected from the group consisting of oxazoline, isoxazole, isoxazolyl, furazan, furazanyl, and substituted forms thereof.

18. The tire tread of claim 1, where said functionalized polymer is obtained by terminating a living polymer with 2-methylthio-2-thiazoline, 2-ethylthio-2-thiazoline, 2-propylthio-2-thiazoline, 2-butylthio-2-thiazoline, 2-pentylthio-2-thiazoline, 2-hexylthio-2-thiazoline, 2-heptylthio-2-thiazoline, 2-dodecylthio-2-thiazoline, 2-phenylthio-2-thiazoline, 2-benzylthio-2-thiazoline, 2-chloro-2-thiazoline, 2-bromo-2-thiazoline, 2-iodo-2-thiazoline, 2-dimethylamino-2-thiazoline, 2-diethylamino-2-thiazoline, 2-methoxy-2-thiazoline, 2-ethoxy-2-thiazoline, 2-(N-methyl-N-3-trimethoxysilylpropyl)-thiazoline, 2-methylthio-1-aza-3-thia-bicyclo[3-4-0]-nonene, or mixtures thereof.

19. The tire tread of claim 1, where said functionalized polymer is obtained by terminating a living polymer with 2-(1,1-dimethyl-2-chloroethyl)-2-oxazoline, 2-(1,1-dimethyl-2-chloroethyl-4,4-dimethyl-2-oxazoline, or mixtures thereof.

20. A rubber formulation comprising:
a rubber component, wherein at least 20% by weight of the rubber component includes a functionalized polymer including an oxygen or sulfur-containing azaheterocycle; and
from about 20 to about 125 parts by weight of a filler component per 100 part by weight rubber, where said filler component comprises at least 1% by weight of an oxidized carbon black.
